(19) United States
(12) Patent Application Publication
(10) Pub. No.: US 2010/0248074 A1
(43) Pub. Date: Sep. 30, 2010

(54) MEMBRANE ELECTRODE ASSEMBLY FOR DIRECT OXIDATION FUEL CELL AND DIRECT OXIDATION FUEL CELL INCLUDING THE SAME

(76) Inventors: Hideyuki UEDA, Osaka (JP); Takashi Akiyama, Osaka (JP); Hiroaki Matsuda, Osaka (JP)

Correspondence Address: MCDERMOTT WILL & EMERY LLP, 600 13TH STREET, NW, WASHINGTON, DC, 20005-3096, US

(21) Appl. No.: 12/749,907

(22) Filed: Mar. 30, 2010

(30) Foreign Application Priority Data
Mar. 30, 2009 (JP) 2009-081788

(51) Int. Cl. H01M 8/10

(52) U.S. Cl. 429/483

(57) ABSTRACT

A membrane electrode assembly for a direct oxidation fuel cell includes an electrolyte membrane, an anode disposed on one face of the electrolyte membrane, and a cathode disposed on the other face of the electrolyte membrane. The cathode includes a cathode catalyst layer with a first main surface and a second main surface, and the cathode catalyst layer includes a cathode catalyst and a polymer electrolyte. The cathode catalyst layer includes a plurality of first regions and a plurality of second regions, and the first regions and the second regions are different in polymer electrolyte content. The polymer electrolyte content in each of the second regions is lower than the polymer electrolyte content in each of the first regions. The second regions are continuous from the first main surface of the cathode catalyst layer to the second main surface.

### FIELD OF THE INVENTION

The invention relates to direct oxidation fuel cells, which directly use a fuel without reforming it into hydrogen. More particularly, the invention relates to improvements in electrodes for a direct oxidation fuel cell.

### BACKGROUND OF THE INVENTION

With the advancement of ubiquitous network society, there is a large demand for mobile devices such as cellular phones, notebook personal computers, and digital still cameras. As the power source for mobile devices, it is desired to put fuel cells into practical use as early as possible. Fuel cells do not have to be recharged and allow continuous use of devices if only they get refueled.

Among fuel cells, direct oxidation fuel cells are receiving attention and under active research and development. Direct oxidation fuel cells generate power by directly supplying an organic fuel such as methanol or dimethyl ether to the anode without reforming it into hydrogen. An organic fuel has a high theoretical energy density and can be easily stored. Also, the use of an organic fuel allows simplification of a fuel cell system.

A direct oxidation fuel cell has a unit cell composed of a membrane electrode assembly (hereinafter referred to as an “MEA”) sandwiched between separators. The MEA is usually composed of a solid polymer electrolyte membrane (electrolyte membrane) sandwiched between an anode and a cathode, and each of the anode and the cathode includes a catalyst layer and a diffusion layer. Such a direct oxidation fuel cell generates power by supplying a fuel and water to the anode and supplying an oxidant (e.g., oxygen) to the cathode.

For example, the electrode reactions of a direct methanol fuel cell (hereinafter referred to as a “DMFC”), which uses methanol as the fuel, are as follows.

Anode: CH₃OH+H₂O→CO₂+6H⁺+6e⁻

Cathode: 3/2O₂+6H⁺+6e⁻→3H₂O

On the anode, methanol reacts with water to produce carbon dioxide, protons, and electrons. The protons produced on the anode migrate to the cathode through the electrolyte membrane, and the electrons migrate to the cathode through an external circuit. On the cathode, these protons and electrons combine with oxygen to form water.

However, practical utilization of DMFCs has some problems.

One of the problems relates to the durability of the MEA. With the passage of power generation time, water produced by the reaction of the cell and/or dragged from the anode accumulates in liquid state inside the cathode catalyst layer and/or at the interface between the cathode catalyst layer and the cathode diffusion layer. The accumulated water impairs the diffusion of the oxidant in the cathode, thereby increasing cathodic concentration overvoltage. This is believed to be the main cause of initial deterioration of the power generation performance of DMFCs.

Further, the initial deterioration is strongly affected by methanol crossover (hereinafter referred to as “MCO”), which is a phenomenon of unreacted methanol reaching the cathode through the electrolyte membrane. That is, in the cathode catalyst layer, the oxidation reaction of crossover methanol occurs simultaneously with the reduction reaction of oxygen, which is the normal electrode reaction of the cathode. Thus, particularly when high concentration methanol is used as the fuel, the amount of MCO increases with the passage of power generation time, thereby significantly increasing cathodic activation overvoltage. In addition, carbon dioxide produced further impairs the diffusion of the oxidant, thereby significantly lowering the power generation performance.

To solve such problems, a large number of proposals have been made to improve the structure of the cathode catalyst layer itself.

For example, Japanese Laid-Open Patent Publication No. 2006-185800 (Document 1) discloses a transfer sheet including a cathode catalyst layer whose polymer electrolyte concentration in the thickness direction increases toward the electrolyte membrane. Document 1 intends to provide an MEA having a small resistance at the interface between the catalyst layer and the electrolyte membrane and in which an oxidant can be sufficiently supplied to the cathode catalyst layer.

Japanese Laid-Open Patent Publication No. 2008-186798 (Document 2), which is not directed to a DMFC, discloses that the porosity of the cathode catalyst layer in the thickness direction thereof is increased toward the electrolyte membrane side of the cathode catalyst layer. Document 2 intends to provide an MEA having good power generation performance and durability by making both water removal ability and proton conductivity high.

Japanese Laid-Open Patent Publication No. 2006-108031 (Document 3), which is also not directed to a DMFC, discloses a cathode whose water repellency decreases from the catalyst layer toward the diffusion layer. Document 3 intends to provide an MEA having improved power generation stability by improving water removal ability.

U.S. Patent Publication No. 2008/0206616 (Document 4) discloses a catalyst layer for a DMFC in which the concentration of polymer electrolyte is changed in the direction parallel to the main surface of the electrolyte membrane and/or the direction perpendicular to the main surface. Document 4 recites that the concentrations of various components of the catalyst layer are changed as a means for improving methanol diffusion and achieving a sufficient loading amount of catalyst without sacrificing electronic conductivity.

### BRIEF SUMMARY OF THE INVENTION

However, with the above-described conventional configurations, it is difficult to alleviate the problem of the catalyst layer whose pore volume decreases significantly due to swelling of the polymer electrolyte with crossover methanol and water, while ensuring proton conductivity. To obtain a catalyst layer with a small cathodic overvoltage, many problems have yet to be solved.

In the case of the technique disclosed by Document 1, the polymer electrolyte concentration of the cathode catalyst layer is merely changed in the thickness direction. Thus, throughout the catalyst layer, it is difficult to suppress the decrease in pore volume due to swelling of the polymer electrolyte, while ensuring proton conductivity. In particular, since the swelling of the polymer electrolyte increases with power generation time, the diffusion of the oxidant is thought to be impaired in the area of the catalyst layer on the electrolyte membrane side where the polymer electrolyte concentration is high, thereby resulting in poor durability of the MEA.

In the case of the techniques disclosed by Documents 2 and 3, no consideration is given to the impact of swelling of the polymer electrolyte with crossover methanol. In an early stage of power generation, the power generation performance is relatively good due to sufficient oxidant diffusion and water removal. However, with the passage of power generation time, the polymer electrolyte gradually swells, so the pore volume decreases, thereby making it difficult to supply the oxidant to the depths of the catalyst layer in a reliable manner. Thus, the power generation performance is thought to deteriorate sharply.

In the case of the technique disclosed by Document 4, the concentration of polymer electrolyte is merely changed in the direction parallel to the surface of the catalyst layer and/or the direction perpendicular thereto. Hence, in the same manner as in Document 1, it is difficult to suppress the decrease in the pore volume of the whole catalyst layer due to swelling of the polymer electrolyte, while ensuring proton conductivity.

Further, when the amount (concentration) of polymer electrolyte contained in the cathode catalyst layer is changed in the direction perpendicular to the thickness direction thereof so that it is larger in the area of the cathode catalyst layer facing the upstream of the fuel flow channel than in the area facing the downstream thereof, the swelling of the polymer electrolyte is further promoted in the area of the cathode catalyst layer facing the upstream of the fuel flow channel since the amount of crossover methanol is large. Thus, the porosity of the upstream area of the cathode catalyst layer decreases significantly. As a result, the power generation performance is thought to deteriorate.

The invention intends to solve the above-described problems with conventional art. It is therefore an object of the invention to provide a direct oxidation fuel cell having excellent power generation performance and durability.

One aspect of the invention relates to a membrane electrode assembly for a direct oxidation fuel cell. The membrane electrode assembly includes an electrolyte membrane; an anode disposed on one face of the electrolyte membrane; and a cathode disposed on the other face of the electrolyte membrane. The cathode includes a cathode catalyst layer with a first main surface and a second main surface, and the cathode catalyst layer includes a cathode catalyst and a polymer electrolyte. The cathode catalyst layer includes a plurality of first regions and a plurality of second regions, and the first regions and the second regions are different in the polymer electrolyte content. The polymer electrolyte content in each of the second regions is lower than the polymer electrolyte content in each of the first regions. The second regions are continuous from the first main surface of the cathode catalyst layer to the second main surface.

Also, another aspect of the invention relates to a direct oxidation fuel cell including the membrane electrode assembly.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a longitudinal sectional view schematically showing the structure of a unit cell included in a direct oxidation fuel cell according to an embodiment of the invention;

FIG. 2 is a longitudinal sectional view schematically showing a cathode catalyst layer included in a direct oxidation fuel cell according to an embodiment of the invention;

FIG. 3 is a longitudinal sectional view schematically showing a cathode catalyst layer included in a direct oxidation fuel cell according to another embodiment of the invention;

FIG. 4 is a longitudinal sectional view schematically showing a cathode catalyst layer included in a direct oxidation fuel cell according to still another embodiment of the invention; and

FIG. 5 is a schematic view showing the structure of an exemplary spray coater used for forming a cathode catalyst layer.

### DETAILED DESCRIPTION OF THE INVENTION

The direct oxidation fuel cell according to an embodiment of the invention includes at least one unit cell. The unit cell includes: a membrane electrode assembly composed of an electrolyte membrane sandwiched between an anode and a cathode; an anode separator having a fuel flow channel for supplying a fuel to the anode; and a cathode separator having an oxidant flow channel for supplying an oxidant to the cathode. The cathode includes a cathode catalyst layer in contact with the electrolyte membrane, and a cathode diffusion layer in contact with the cathode separator. The cathode catalyst layer includes at least a cathode catalyst and a polymer electrolyte, and has a first main surface and a second main surface. The cathode catalyst layer includes a plurality of first regions and a plurality of second regions, and the first regions and the second regions are different in the polymer electrolyte content. The polymer electrolyte content in each of the second regions is lower than the polymer electrolyte content in each of the first regions. The second regions are disposed continuously from the first main surface of the cathode catalyst layer to the second main surface.

As used herein, the first main surface and the second main surface refer to opposite faces of the cathode catalyst layer in the thickness direction. The first main surface refers to the face of the cathode catalyst layer in contact with the electrolyte membrane. The second main surface refers to the face which is on the other side of the cathode catalyst layer from the first main surface and which is in contact with the cathode diffusion layer. That is, the second regions are disposed continuously in the thickness direction of the cathode catalyst layer from the first main surface of the cathode catalyst layer, which is in contact with the electrolyte membrane, to the second main surface, which is on the other side of the cathode catalyst layer.

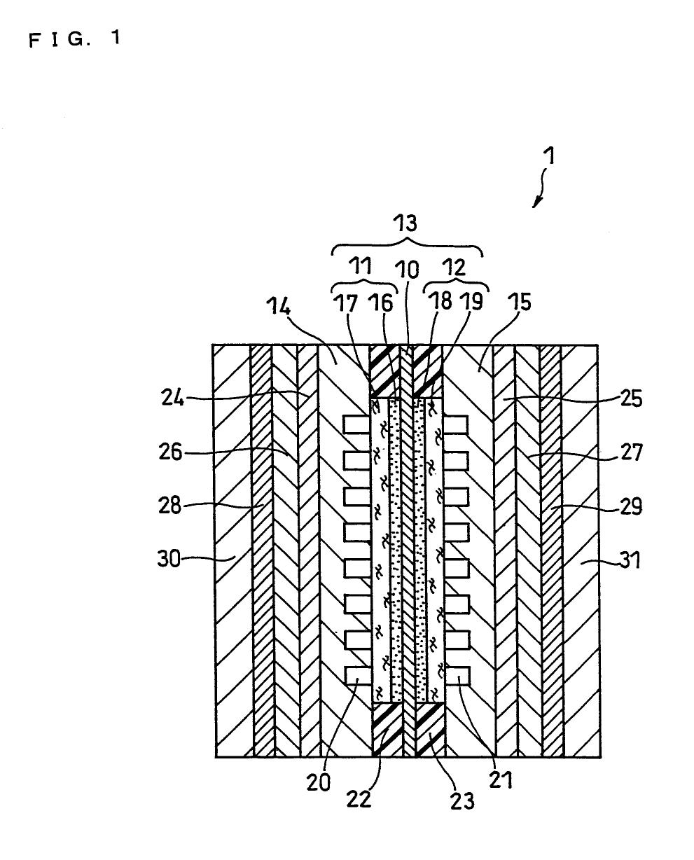

FIG. 1 is a longitudinal sectional view of a unit cell included in a direct oxidation fuel cell according to one embodiment of the invention.

A unit cell 1 illustrated in FIG. 1 includes: a membrane electrode assembly (MEA) 13 composed of an electrolyte membrane 10 and an anode 11 and a cathode 12 sandwiching the electrolyte membrane 10; and an anode separator 14 and a cathode separator 15 sandwiching the MEA 13. The anode separator 14 is in contact with the anode 11, while the cathode separator 15 is in contact with the cathode 12.

The anode 11 includes an anode catalyst layer 16 in contact with the electrolyte membrane 10 and an anode diffusion layer 17 in contact with the anode separator 14. The cathode 12 includes a cathode catalyst layer 18 in contact with the electrolyte membrane 10 and a cathode diffusion layer 19 in contact with the cathode separator 15.

The anode separator 14 has, on the face facing the anode 11, a fuel flow channel 20 for supplying a fuel and discharging unused fuel and reaction products. The cathode separator 15 has, on the face facing the cathode 12, an oxidant flow channel 21 for supplying an oxidant and discharging unused oxidant and reaction products.

Disposed around the anode 11 and the cathode 12 are gaskets 22 and 23, respectively, which sandwich the electrolyte membrane 10 to prevent leakage of the fuel, oxidant, and reaction products.

Further, in the unit cell 1 of FIG. 1, the separators 14 and 15 are sandwiched between current collector plates 24 and 25, sheet heaters 26 and 27, insulator plates 28 and 29, and end plates 30 and 31, respectively. The unit cell 1 is secured by clamping means (not shown). The direct oxidation fuel cell according to an embodiment of the invention may include a plurality of unit cells 1. In this case, the unit cells 1 are connected, for example, in series.

The cathode catalyst layer 18 can include cathode catalyst particles and a polymer electrolyte. The cathode catalyst particles included in the cathode catalyst layer 18 can be catalyst metal fine particles such as platinum (Pt) fine particles. The catalyst metal fine particles may be loaded on conductive carbon particles. That is, the cathode catalyst particles may be loaded on conductive carbon particles. The conductive carbon particles can be any material known in the art. An example of such material is carbon black.

The polymer electrolyte included in the cathode catalyst layer 18 is not particularly limited if it has good characteristics such as proton conductivity, heat resistance, and chemical stability. Examples of such polymer electrolytes include perfluorocarbon sulfonic acid ionomers (e.g., Nafion (trade name), Flemion (trade name)). The polymer electrolyte included in the cathode catalyst layer 18 may be the same as or different from the polymer electrolyte of the electrolyte membrane 10.

The thickness of the cathode catalyst layer 18 can be in the range of 20 to 200 μm.

With reference to drawings, the cathode catalyst layer 18 is described.

### Embodiment 1

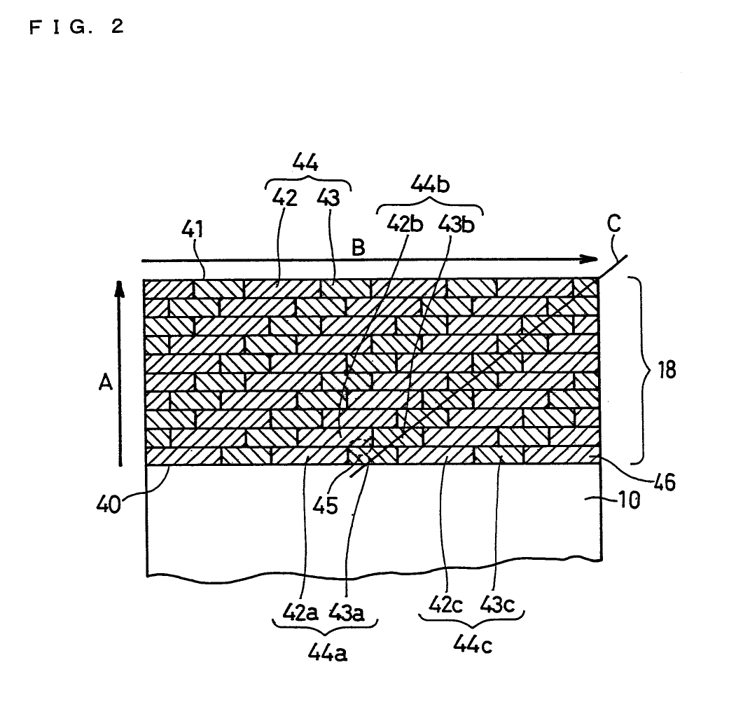

FIG. 2 is a longitudinal sectional view of an exemplary cathode catalyst layer included in a direct oxidation fuel cell according to an embodiment of the invention. FIG. 2 illustrates the cathode catalyst layer 18 and the electrolyte membrane 10 in contact with the cathode catalyst layer 18.

The cathode catalyst layer 18 includes a plurality of first regions 42 and a plurality of Second regions 43. The first regions 42 and the second regions 43 are different in the polymer electrolyte content. The polymer electrolyte content in each of the second regions 43 is lower than the polymer electrolyte content in each of the first regions 42. In the case of the cathode catalyst layer 18 of FIG. 2, the cathode catalyst layer 18 comprises a plurality of thin layers 46 accumulated in the thickness direction, and each thin layer 46 includes at least one first region 42 and at least one second region 43. In the cathode catalyst layer 18 of FIG. 2, the first regions 42 and the second regions 43 are alternately arranged in each thin layer 46.

The number of the thin layers 46 accumulated is preferably, for example, 10 to 60, and more preferably 30 to 50.

In this embodiment, the second regions 43 are disposed continuously from a first main surface 40 of the cathode catalyst layer 18 to a second main surface 41. In FIG. 2, the second regions are represented by 43, and the second regions 43 at different positions are represented by 43a, 43b, 43c, and the like for convenience sake. This also applies to the first regions 42.

In the cathode catalyst layer 18 of FIG. 2, a predetermined second region 43 included in a predetermined thin layer 46 is disposed so as to contact another second region 43 included in another thin layer 46 accumulated on the predetermined thin layer 46. In this way, the plurality of second regions 43 are disposed continuously from the first main surface 40 of the cathode catalyst layer 18 to the second main surface 41.

The cathode catalyst layer 18, i.e., the first regions 42 and the second regions 43, has pores. The first regions 42, which have a higher polymer electrolyte content than the second regions 43, have good proton conductivity, although the pore volume decreases significantly due to swelling of the polymer electrolyte with crossover methanol. The second regions 43, which have a lower polymer electrolyte content than the first regions 42, have low proton conductivity, but the decrease in the porosity of the second regions 43 is suppressed even when the polymer electrolyte swells with crossover methanol. Thus, in the second regions 43, oxidant diffusion and product water'removal ability are improved.

In particular, as illustrated in FIG. 2, when the second regions 43 are disposed continuously from the first main surface 40 of the cathode catalyst layer 18 to the second main surface 41, it is possible to ensure that the cathode catalyst layer 18 contains sufficient paths effective for oxidant diffusion and water removal across the thickness of the cathode catalyst layer 18. As a result, the three-phase interface, which is the electrode reaction site, is enlarged, and cathodic overvoltage becomes small and stable. Further, since cathodic overvoltage can be reduced, the durability of the fuel cell can be enhanced.

Further, in the cathode catalyst layer 18, preferably, at least the second regions 43 are continuous slantwise with respect to the thickness direction (direction parallel to the arrow A) of the cathode catalyst layer 18, as illustrated in FIG. 2. In this case, preferably, a first region 42b and a second region 43a, which are adjacent in the thickness direction of the cathode catalyst layer 18, are partially in contact with each other at a contact portion 45.

When the contact portion 45 is provided between the first region 42b and the second region 43a which are adjacent in the thickness direction, the contact area between the first regions 42 and the second regions 43 can be increased. An increase in the contact area between the first regions 42 and the second regions 43 results in an increase in the likelihood of contact between the protons supplied to the cathode catalyst layer 18 from the electrolyte membrane 10 and the oxidant supplied to the cathode catalyst layer 18 from the cathode diffusion layer (not shown). That is, it is possible to increase the three-phase interface where the cathode catalyst, the polymer electrolyte, and the oxidant coexist, and to obtain a cathode catalyst layer with a small overvoltage.

In this embodiment, it is also preferable that the plurality of first regions 42 be disposed continuously from the first main surface 40 of the cathode catalyst layer 18 to the second main surface 41. This ensures that the cathode catalyst layer 18 contains sufficient paths effective for proton conduction. As a result, it is possible to increase the three-phase interface (electrode reaction site) in the cathode catalyst layer 18 where the cathode catalyst, the polymer electrolyte, and the oxidant coexist, and to decrease the overvoltage of the cathode catalyst layer 18.

When the first regions 42 are disposed continuously from the first main surface 40 of the cathode catalyst layer 18 to the second main surface 41, the first regions 42 may or may not be continuous slantwise with respect to the thickness direction of the cathode catalyst layer 18.

It is particularly preferable that the first regions 42 be continuous slantwise with respect to the thickness direction (direction parallel to the arrow A) of the cathode catalyst layer 18. When both the first regions 42 and the second regions 43 are disposed continuously from the first main surface 40 of the cathode catalyst layer 18 to the second main surface 41 slantwise with respect to the thickness direction of the cathode catalyst layer 18, it is possible to further increase the contact portions 45 between the first regions 42 and the second regions 43. That is, it is possible to further increase the three-phase interface where the cathode catalyst, the polymer electrolyte, and the oxidant coexist, and to obtain a cathode catalyst layer with a smaller overvoltage.

In FIG. 2, the first regions 42 and the second regions 43 are disposed continuously in the direction substantially parallel to the line C. Specifically, the first regions 42 and the second regions 43 are continuous from the first main surface to the second main surface along the line slanted at a predetermined angle with respect to the thickness direction of the cathode catalyst layer 18.

As long as at least the second regions 43 are disposed continuously from the first main surface 40 of the cathode catalyst layer 18 to the second main surface 41, the first regions 42 and the second regions 43 may be disposed regularly or irregularly in the thickness direction of the cathode catalyst layer 18 and/or the direction perpendicular to the thickness direction. Such configuration can enhance the evenness of the electrode reaction in the whole area of the cathode catalyst layer 18, thereby making it possible to significantly suppress deterioration of the cathode catalyst layer 18.

A description is made of an example in which the first regions 42 and the second regions 43 are disposed regularly in the thickness direction of the cathode catalyst layer 18 and the direction perpendicular to the thickness direction.

Specifically, the cathode catalyst layer 18 may be an aggregate of a plurality of units 44 each including-one first region 42 and one second region 43. In FIG. 2, the units 44 are regularly disposed in the thickness direction (direction parallel to the arrow A) of the cathode catalyst layer 18 and the direction (direction parallel to the arrow B) perpendicular to the thickness direction. In FIG. 2, the units 44 are represented by 44, but the units 44 at different positions are represented by 44a, 44b, 44c, and the like for convenience sake.

In the direction parallel to the arrow B in the cathode catalyst layer 18 of FIG. 2, for example, a unit 44a and a unit 44c are disposed so that a second region 43a of the unit 44a contacts a first region 42c of the unit 44c. That is, in the direction parallel to the arrow B, the first regions 42 and the second regions 43 are alternately disposed.

In the direction parallel to the arrow A in the cathode catalyst layer 18 of FIG. 2, the unit 44a and a unit 44b are disposed so that the second region 43a of the unit 44a is partially in contact with a first region 42b of the unit 44b. In this way, by displacing the units 44 adjacent in the thickness direction slightly in the direction parallel to the arrow B, both the first regions 42 and the second regions 43 can be disposed continuously from the first main surface 40 of the cathode catalyst layer 18 to the second main surface 41 slantwise with respect to the thickness direction of the cathode catalyst layer 18.

The cathode catalyst layer 18 may further include additional one or more regions (e.g., third region, fourth region) having a different polymer electrolyte content than the first regions 42 and the second regions 43. The volume ratio of the total of the additional one or more regions to the cathode catalyst layer 18 is preferably lower than the volume ratio of the total of the first regions 42 and the second regions 43 to the cathode catalyst layer 18.

### Embodiment 2

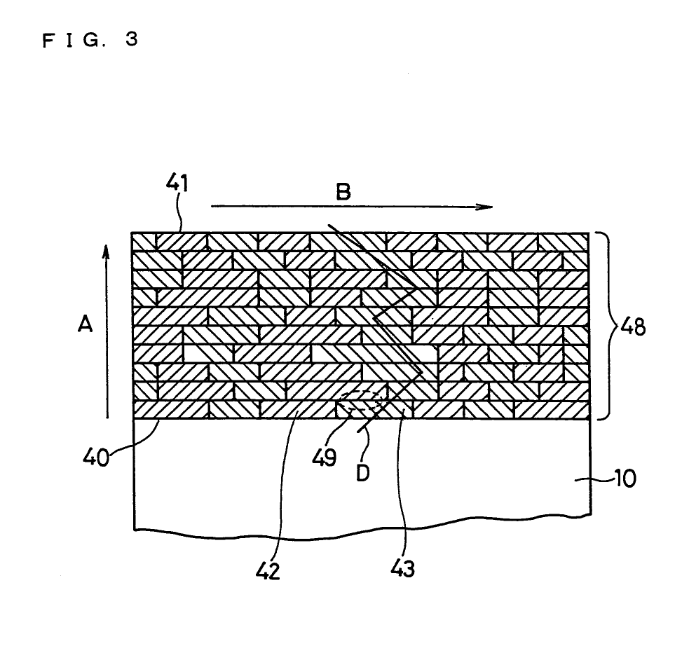

FIG. 3 is a longitudinal sectional view of an exemplary cathode catalyst layer included in a direct oxidation fuel cell according to another embodiment of the invention. In FIG. 3, the same constituent elements as those of FIG. 2 are given the same numbers.

A cathode catalyst layer 48 of FIG. 3 is different from the cathode catalyst layer 18 of FIG. 2 in the arrangement of the first regions 42 and the second regions 43.

Specifically, in the cathode catalyst layer 48, the second regions 43 are continuous in a zigzag from the first main surface 40 of the cathode catalyst layer 48 to the second main surface 41. In the cathode catalyst layer 48 of FIG. 3, the second regions 43 are disposed in a zigzag like the polygonal line D.

When the cathode catalyst layer 48 has the arrangement of the second regions 43 as illustrated in FIG. 3, the second regions 43 are continuous from the first main surface 40 of the cathode catalyst layer 48 to the second main surface 41. It is thus possible to ensure that the cathode catalyst layer 48 contains sufficient paths effective for oxidant diffusion and water removal across the thickness of the cathode catalyst layer 48. Hence, the three-phase interface (electrode reaction site) is enlarged, and cathodic overvoltage becomes small and stable. As a result, the durability of the fuel cell can be enhanced

Further, in the cathode catalyst layer 48 of FIG. 3, the second regions 43 are disposed in a zigzag from the first main surface 40 to the second main surface 41. Preferably, each first region 42 and each second region 43 which are adjacent in the thickness direction of the cathode catalyst layer 48 are partially in contact with each other. In this case, in the same manner as in Embodiment 1, a contact portion 49 is provided between each first region 42 and each second region 43 which are adjacent in the thickness direction of the cathode catalyst layer 48, and the contact area between the first regions 42 and the second regions 43 can be increased. An increase in the contact area between the first regions 42 and the second regions 43 results in an increase in the three-phase interface where the cathode catalyst, the polymer electrolyte, and the oxidant coexist. As a result, the overvoltage of the cathode catalyst layer 48 can be decreased.

In this embodiment, it is also preferable that the first regions 42 be continuous from the first main surface 40 of the cathode catalyst layer 48 to the second main surface 41. This ensures that the cathode catalyst layer 48 contains sufficient paths effective for proton conduction in the same manner as in Embodiment 1. As a result, it is possible to increase the three-phase interface (electrode reaction site) in the cathode catalyst layer 48 where the cathode catalyst, the polymer electrolyte, and the oxidant coexist, and to further decrease the overvoltage of the cathode catalyst layer 48.

When the first regions 42 are continuous from the first main surface 40 of the cathode catalyst layer 48 to the second main surface 41, the first regions 42 may or may not be continuous in a zigzag in the thickness direction of the cathode catalyst layer 48.

In this embodiment, also, as long as at least the second regions 43 are continuous in a zigzag from the first main surface 40 of the cathode catalyst layer 48 to the second main surface 41 in the thickness direction of the cathode catalyst layer 48, the first regions 42 and the second regions 43 may be disposed regularly or irregularly in the thickness direction of the cathode catalyst layer 48 and/or the direction perpendicular to the thickness direction. It is noted that FIG. 3 shows an example in which the first regions 42 and the second regions 43 are disposed irregularly in the thickness direction of the cathode catalyst layer 48 and the direction perpendicular to the thickness direction.

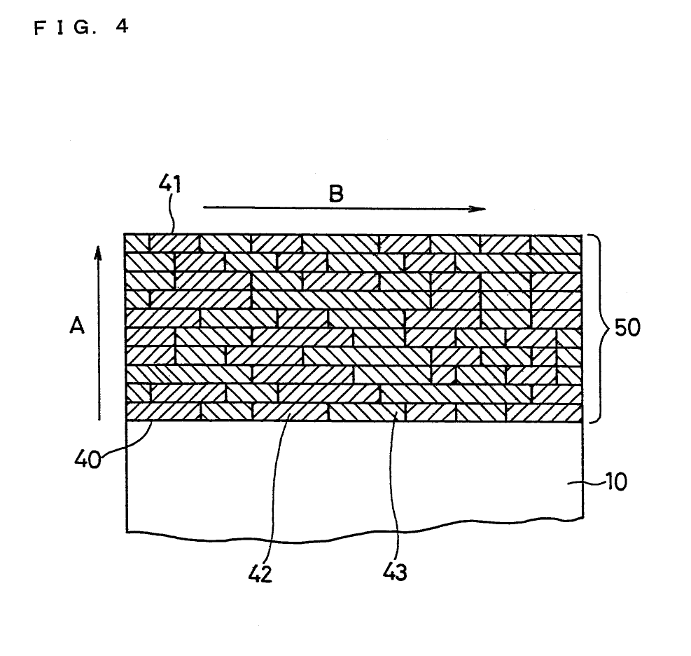

FIG. 4 shows an exemplary cathode catalyst layer in which only the second regions 43 are continuous in a zigzag from the first main surface 40 of a cathode catalyst layer 50 to the second main surface 41. In FIG. 4, the same constituent elements as those of FIG. 3 are given the same numbers.

In the cathode catalyst layer 50 of FIG. 4, the second regions 43 are also continuous in a zigzag from the first main surface 40 of the cathode catalyst layer 50 to the second main surface 41. Thus, as described above, the three-phase interface (electrode reaction site) is enlarged, and cathodic overvoltage becomes small and stable. As a result, the durability of the fuel cell can be enhanced.

Further, in the cathode catalyst layer 50 of FIG. 4, it is also preferable that each first region 42 and each second region 43 which are adjacent in the thickness direction of the cathode catalyst layer 50 be partially in contact with each other. In this case, in the same manner as described above, a contact portion is provided between each first region 42 and each second region 43 which are adjacent in the thickness direction of the cathode catalyst layer 50, and the contact area between the first regions 42 and the second regions 43 can be increased. As a result, the overvoltage of the cathode catalyst layer 50 can be decreased in the same manner as described above.

In this embodiment, in the same manner as in Embodiment 1, the cathode catalyst layer may further include additional one or more regions (e.g., third region, fourth region) having a different polymer electrolyte content than the first regions 42 and the second regions 43. The volume ratio of the total of the additional one or more regions to the cathode catalyst layer is preferably lower than the volume ratio of the total of the first regions 42 and the second regions 43 to the cathode catalyst layer.

Next, the first regions 42 and the second regions 43 are described. The following description applies to both Embodiments 1 and 2.

The polymer electrolyte content in the first regions 42 is preferably 20 to 30% by weight, and the polymer electrolyte content in the second regions 43 is preferably 10 to 20% by weight. In this case, it is possible to form a cathode catalyst layer with a small overvoltage in which proton conductivity is sufficient and the decrease in pore volume due to swelling of the polymer electrolyte is suppressed. The polymer electrolyte content in a single first region 42 is preferably uniform over the whole region. Likewise, the polymer electrolyte content in a single second region 43 is preferably uniform over the whole region.

The kinds of the polymer electrolytes included in the first regions 42 and the second regions 43 may be the same or different. In terms of costs etc., the kinds of the polymer electrolytes included in the first regions 42 and the second regions 43 are preferably the same.

The cathode catalyst is preferably loaded on conductive carbon particles. In this case, the weight ratio B of the polymer electrolyte to the conductive carbon particles in the second regions 43 is preferably lower than the weight ratio A of the polymer electrolyte to the conductive carbon particles in the first regions 42. Such configuration further decreases cathodic overvoltage, thereby making it possible to significantly improve the durability of the fuel cell.

The weight ratio A of the polymer electrolyte to the conductive carbon particles in the first regions 42 is preferably from 0.5 to 0.7, and the weight ratio B of the polymer electrolyte to the conductive carbon particles in the second regions 43 is preferably from 0.3 to 0.5. When the weight ratio A and the weight ratio B are in these ranges, it is possible to avoid a decrease in the pore volume of the cathode catalyst layer due to excessive polymer electrolyte in the cathode catalyst layer and a decrease in proton conductivity due to insufficient polymer electrolyte. As a result, cathodic overvoltage can be significantly decreased.

Further, the difference (A−B) between the weight ratio A and the weight ratio B is preferably 0.1 or more. By setting the difference (A−B) between the weight ratio A and the weight ratio B to 0.1 or more, it is possible to obtain a cathode catalyst layer with an optimum balance among basic characteristics such as oxidant diffusibility, water removal ability, proton conductivity, and electronic conductivity.

The weight ratios A in the first regions 42 at different positions of the cathode catalyst layer may be the same. Alternatively, the weight ratios A in the first regions 42 at different positions of the cathode catalyst layer may be different if the weight ratio A is in the range of 0.5 to 0.7. Likewise, the weight ratios B in the second regions 43 at different positions of the cathode catalyst layer may be the same. Alternatively, the weight ratios B in the second regions 43 at different positions of the cathode catalyst layer may be different if the weight ratio B is in the range of 0.3 to 0.5.

The maximum dimension of the first region 42 in the thickness direction of the cathode catalyst layer is preferably 1 to 10 μm. The maximum dimension of the first region 42 in the plane direction perpendicular to the thickness direction of the cathode catalyst layer is preferably 5 to 20 mm.

The maximum dimension of the second region 43 in the thickness direction of the cathode catalyst layer is preferably 1 to 10 μm. The maximum dimension of the second region 43 in the plane direction perpendicular to the thickness direction of the cathode catalyst layer is preferably 5 to 20 mm.

The maximum dimensions of the first region 42 and the second region 43 in the thickness direction of the cathode catalyst layer and the plane direction perpendicular to the thickness direction of the cathode catalyst layer can be evaluated, for example, by mapping analysis of F atoms and S atoms by an EPMA (wavelength-dispersive X-ray microanalyzer).

In the cathode catalyst layer, the volume ratio of the first regions 42 is preferably higher than the volume ratio of the second regions 43. For example, the volume ratio of the first regions 42 to the second regions 43 is preferably from 1.2 to 2. This ensures sufficient proton conductivity, i.e., sufficient prevention of drying of the cathode catalyst layer by the oxidant.

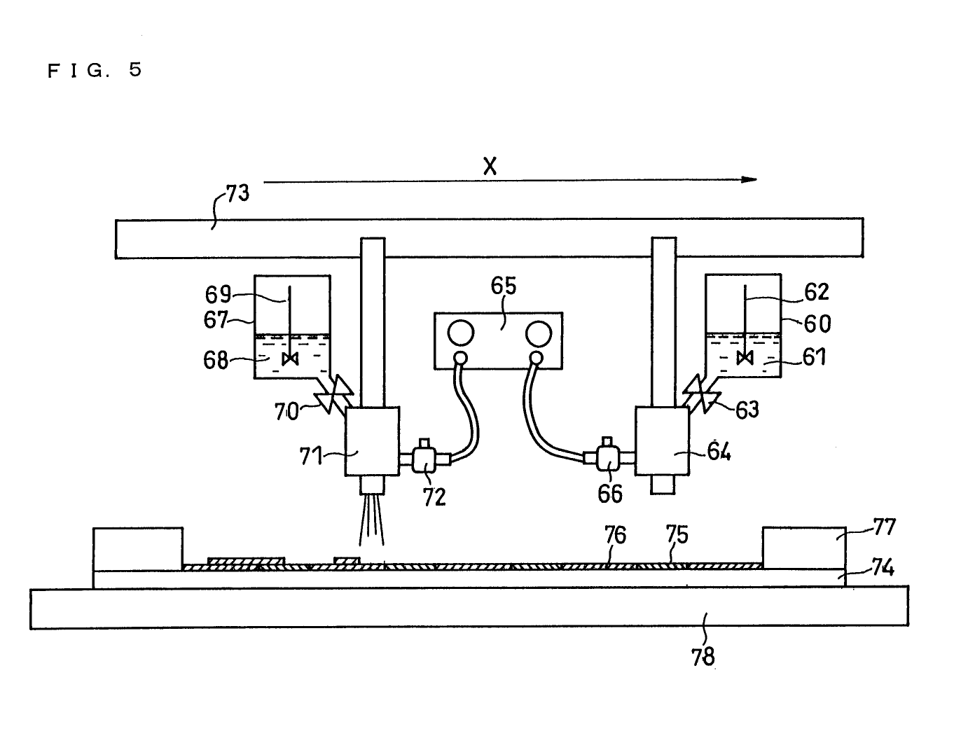

The cathode catalyst layer can be produced, for example, by using a spray coater as illustrated in FIG. 5. FIG. 5 is a schematic view showing the structure of a spray coater for forming the cathode catalyst layer.

The cathode catalyst layer can be produced, for example, by a method including the steps of:
(a) preparing a first catalyst ink for forming first regions;
(b) preparing a second catalyst ink for forming second regions having a lower polymer electrolyte content than the first regions; and
(c) applying the first catalyst ink and the second catalyst ink onto an electrolyte membrane in a predetermined pattern and drying them to form a cathode catalyst layer including the first regions and the second regions, the second regions being continuous from the first main surface to the second main surface in the thickness direction.

A tank 60 of a spray coater is filled with a first catalyst ink 61 for forming first regions 75. The first catalyst ink 61 is constantly flowing by means of a stirring device 62 and fed to a spray gun 64 through an open/close valve 63. The first catalyst ink 61 is forced out of the spray gun 64 together with a spray gas. The spray gas is fed to the spray gun 64 through a gas pressure adjustor 65 and a gas flow rate adjustor 66.

A tank 67 is filled with a second catalyst ink 68 for forming second regions 76 having a lower polymer electrolyte content than the first regions 75. The second catalyst ink 68 is constantly flowing by means of a stirring device 69, and fed to a spray gun 71 through an open/close valve 70. The second catalyst ink 68 is forced out of the spray gun 71 together with a spray gas. The spray gas is fed to the spray gun 71 through the gas pressure adjustor 65 and a gas flow rate adjustor 72.

The spray gas for spraying the first catalyst ink 61 and the second catalyst ink 68 can be, for example, nitrogen gas.

In the apparatus of FIG. 5, the spray guns 64 and 71 are coupled to an actuator 73 and are capable of moving from a given position at a given speed in two directions: the X axis parallel to the arrow X; and the Y axis perpendicular to the X axis and the plane of paper of FIG. 5. Thus, the arrangement of the first regions 75 and the second regions 76 with a lower polymer electrolyte content than the first regions 75 can be freely changed.

The spray guns 64 and 71 are installed above an electrolyte membrane 74. They are capable of moving while spraying the catalyst inks 61 and 68, so that a cathode catalyst layer including the first regions 75 and the second regions 76 can be formed on the electrolyte membrane 74. The areas of the electrolyte membrane 74 to which the catalyst inks 61 and 68 are to be applied can be adjusted by using a mask 77.

In forming the cathode catalyst layer, it is preferable to control the surface temperature of the electrolyte membrane 74. The surface temperature of the electrolyte membrane 74 can be controlled by using a heater 78 disposed so as to contact the electrolyte membrane 74.

It is noted that FIG. 5 illustrates a process of forming the second regions 76, in which the second catalyst ink 68 is being sprayed from the spray gun 71 and the spray gun 64 is idle.

The polymer electrolyte content in the first regions 75 and the second regions 76 can be controlled by adjusting the polymer electrolyte content in the first catalyst ink 61 and the second catalyst ink 68. In producing a cathode catalyst layer, the first regions at different positions of the cathode catalyst layer may have different weight ratios A if the weight ratio is, for example, in the range of 0.5 to 0.7. Likewise, the second regions at different positions of the cathode catalyst layer may have different weight ratios B if the weight ratio is, for example, in the range of 0.3 to 0.5.

The actuator 73 for controlling the movement of the spray guns 64 and 71 may be controlled by a computer. That is, the positions to which the first catalyst ink 61 and the second catalyst ink 68 are applied can be controlled by a computer. In this case, even when the first regions 75 and the second regions 76 are disposed regularly or irregularly, the second regions 76 can be easily disposed continuously from the first main surface of the cathode catalyst layer to the second main surface.

With reference to FIG. 1, other constituent components than the cathode catalyst layer are described.

The cathode diffusion layer 19 can be a conductive porous substrate having oxidant diffusibility, water removal ability, and electronic conductivity. Examples of such conductive porous substrates include carbon paper, carbon cloth, and carbon felt. Also, such a conductive porous substrate may be treated to make it water-repellent by a known technique. Further, a water-repellent carbon layer (not shown) may be formed on the surface of the conductive porous substrate on the cathode catalyst layer 18 side.

The anode catalyst layer 16 is composed mainly of: catalyst metal fine particles or conductive carbon particles loaded with catalyst metal fine particles; and a polymer electrolyte. The catalyst metal fine particles contained in the anode catalyst layer 16 can be, for example, platinum-ruthenium (Pt—Ru) alloy fine particles. The polymer electrolyte contained in the anode catalyst layer 16 preferably has good properties such as proton conductivity, heat resistance, and chemical stability. The polymer electrolyte contained in the anode catalyst layer 16 can be the same as the polymer electrolyte contained in the cathode catalyst layer.

The anode diffusion layer 17 can be a conductive porous substrate having fuel diffusibility, ability to remove carbon dioxide produced by power generation, and electronic conductivity. Examples of such conductive porous substrates include carbon paper, carbon cloth, and carbon felt. Also, such a conductive porous substrate may be treated to make it water-repellent by a known technique. Further, a water-repellent carbon layer (not shown) may be formed on the surface of the conductive porous substrate on the anode catalyst layer 16 side.

The electrolyte membrane 10 preferably has good properties such as proton conductivity, heat resistance, and chemical stability. The material constituting the electrolyte membrane 10 (polymer electrolyte) is not particularly limited if the electrolyte membrane 10 has the above-described properties.

The material for the separators 14 and 15 is not particularly limited if it has gas tightness, electron conductivity, and electrochemical stability. Also, the shapes of the fuel flow channel 20 and the oxidant flow channel 21 are not particularly limited either.

The current collector plates 24 and 25, the sheet heaters 26 and 27, the insulator plates 28 and 29, and the end plates 30 and 31 can be made of materials known in the art.

### EXAMPLES

The invention is hereinafter described in detail by way of Examples. These Examples, however, are not to be construed as limiting in any way the invention.

### Example 1

### Preparation of Cathode Catalyst Layer

The cathode catalyst layer 18 as illustrated in FIG. 2 was produced.

Pt with a mean particle size of 3 nm was used as the cathode catalyst. The cathode catalyst was loaded on conductive carbon particles with a mean primary particle size of 30 nm. Carbon black (Ketjen black EC available from Mitsubishi Chemical Corporation) was used as the conductive carbon particles. The weight ratio of Pt to the total weight of the conductive carbon particles and Pt was set to 46% by weight.

The conductive carbon particles loaded with the cathode catalyst were ultrasonically dispersed in an aqueous solution of isopropanol. The resultant dispersion was mixed with a predetermined amount of an aqueous solution containing 5% by weight of a polymer electrolyte, and the resultant mixture was stirred with a disperser. In this way, a first catalyst ink and a second catalyst ink were prepared. The weight ratio of the polymer electrolyte to the conductive carbon particles in the first catalyst ink was set to 0.60. The weight ratio of the polymer electrolyte to the conductive carbon particles in the second catalyst ink was set to 0.35. The weight ratio of the polymer electrolyte to the total of the polymer electrolyte, the anode catalyst, and the conductive carbon particles in the first catalyst ink was 24.5% by weight, while the weight ratio of the polymer electrolyte to the total of the polymer electrolyte, the anode catalyst, and the conductive carbon particles in the second catalyst ink was 15.9% by weight. That is, the polymer electrolyte content in the first regions and the polymer electrolyte content in the second regions were 24.5% by weight and 15.9% by weight, respectively.

The polymer electrolyte used was a perfluorocarbonsulfonic acid ionomer (Flemion (trade name) available from Asahi Glass Co., Ltd.).

Next, using the spray coater illustrated in FIG. 5, the cathode catalyst layer 18 with a size of 6 cm×6 cm as illustrated in FIG. 2 was formed on the electrolyte membrane 10. The electrolyte membrane 10 used was a hydrocarbon electrolyte membrane (PolyFuel Inc., membrane thickness 62 μm) cut to a size of 12 cm×12 cm.

The cathode catalyst layer 18 was formed by applying the first catalyst ink and the second catalyst ink 40 times in the thickness direction. Specifically, a first layer was formed on the electrolyte membrane 10 by alternately applying the first catalyst ink and the second catalyst ink thereto in the direction parallel to the arrow B. Subsequently, a second layer was formed on the first layer by alternately applying the first catalyst ink and the second catalyst ink in the direction parallel to the arrow B. At this time, the start position for the application of each catalyst ink for forming the second layer was shifted 1 mm in the direction of the arrow B from the start position for the application of each catalyst ink for forming the first layer (an offset of 1 mm). This operation was repeated to form a cathode catalyst layer consisting of 40 layers.

In this example, the first regions and the second regions were disposed continuously from the first main surface of the cathode catalyst layer to the second main surface slantwise with respect to the thickness direction of the cathode catalyst layer.

In the spray coating, the two spray guns were moved at a speed of 60 mm/sec. Nitrogen gas was used as the spray gas, and the spray pressure was set to 0.15 MPa. The surface temperature of the electrolyte membrane during the spray coating was set to 65° C.

### Preparation of Anode Catalyst Layer

Pt—Ru alloy fine particles (Pt:Ru weight ratio=2:1) having a mean particle size of 3 nm were used as the anode catalyst.

The anode catalyst was ultrasonically dispersed in an aqueous solution of isopropanol, and the resultant dispersion was mixed with an aqueous solution containing 5% by weight of a polymer electrolyte. The resultant mixture was stirred with a disperser to prepare an anode catalyst ink. The weight ratio of the Pt—Ru alloy fine particles to the polymer electrolyte in the anode catalyst ink was set to 2:1. As the polymer electrolyte, a perfluorocarbonsulfonic acid ionomer (Flemion available from Asahi Glass Co., Ltd.) was used.

Next, the anode catalyst ink was applied by a doctor blade method onto the other surface of the electrolyte membrane 10 from the surface with the cathode catalyst layer 18 formed thereon, so that the anode catalyst layer 16 was formed so as to face the cathode catalyst layer 18. In this way, a catalyst coated membrane was produced. The anode catalyst layer 16 had a size of 6 cm×6 cm. The amount of Pt—Ru catalyst contained in the anode catalyst layer was 6.5 mg/cm². As used herein, the amount of Pt—Ru catalyst refers to the value obtained by dividing the amount of Pt—Ru contained in a predetermined region of the anode catalyst layer by the area (projected area) of the predetermined region calculated from the shape of the contour of the predetermined region seen from the direction of the normal thereto.

### (Fabrication of Membrane Electrode Assembly (MEA))

The cathode diffusion layer 19 was laminated on the cathode catalyst layer 18 of the catalyst coated membrane (CCM), and the anode diffusion layer 17 was laminated on the anode catalyst layer 16. The cathode diffusion layer 19 and the anode diffusion layer 17 had a size of 6 cm×6 cm. The cathode diffusion layer 19 used was a carbon cloth with a water-repellent carbon layer formed on one surface thereof (LT2500W available from E-TEK). The anode diffusion layer 17 used was a carbon paper (TGP-H090 available from Toray Industries Inc.). One surface of the carbon paper was provided with a water-repellent carbon layer (PTFE content: 40%) having a thickness of approximately 30 μm. The cathode diffusion layer 19 and the anode diffusion layer 17 were disposed so that their carbon layers were in contact with the cathode catalyst layer 18 and the anode catalyst layer 16.

The resultant laminate was hot pressed (at 130° C. and 4 MPa for 3 minutes) to bond the catalyst layers and the diffusion layers together, thereby producing the anode 11 and the cathode 12.

Next, the gaskets 22 and 23 were thermally bonded (at 130° C. and 4 MPa for 5 minutes) to the electrolyte membrane 10 around the anode 11 and the cathode 12, respectively, so as to sandwich the electrolyte membrane 10, thereby producing the membrane electrode assembly (MEA) 13. Each of the gaskets had a three-layer structure composed of a polyetherimide intermediate layer sandwiched between silicone rubber layers.

### (Production of Evaluation Cell)

The MEA 13 thus obtained was sandwiched between the separators 14 and 15, the current collector plates 24 and 25, the sheet heaters 26 and 27, the insulator plates 28 and 29, and the end plates 30 and 31, all of which had outer dimensions of 12 cm×12 cm. This was secured with clamping rods. The clamping pressure was set to 1.2 MPa (12 kgf/cm²) per separator area.

The separators 14 and 15 were made from a resin-impregnated graphite material of 4 mm in thickness (G347B available from TOKAI CARBON CO., LTD.). The serpentine flow channels 20 and 21 with a width of 1.5 mm and a depth of 1 mm were formed on the separators 14 and 15, respectively. Each of the current collector plates 24 and 25 was a gold-plated stainless steel plate. Each of the sheet heaters 26 and 27 was a SAMICONE heater (available from SAKAGUCHI E.H. VOC CORP.).

The direct oxidation fuel cell produced in the above manner was referred to as a fuel cell A.

### Example 2

A fuel cell B was produced in the same manner as in Example 1, except that the weight ratio of the polymer electrolyte to the conductive carbon particles in the first catalyst ink was set to 0.55, while the weight ratio of the polymer electrolyte to the conductive carbon particles in the second catalyst ink was set to 0.45. The polymer electrolyte content in the first regions was set to 22.9% by weight, while the polymer electrolyte content in the second regions was set to 19.5% by weight.

### Example 3

A fuel cell C was produced in the same manner as in Example 1, except that the cathode catalyst layer 48 as illustrated in FIG. 3 was formed. Specifically, the first catalyst ink and the second catalyst ink were sprayed alternately and repeatedly while the start position for the spray application of each of the first and second catalyst inks for forming each layer was shifted in the direction of the arrow B. In this example, the first regions and the second regions were disposed continuously in a zigzag from the first main surface of the cathode catalyst layer to the second main surface.

### Example 4

A fuel cell D was produced in the same manner as in Example 1, except that the cathode catalyst layer 50 as illustrated in FIG. 4 was formed. Specifically, the first catalyst ink and the second catalyst ink were sprayed alternately and repeatedly while the start position for the spray application of each of the first and second catalyst inks for forming each layer was shifted in the direction of the arrow B. In this example, only the second regions were disposed continuously in a zigzag from the first main surface of the cathode catalyst layer to the second main surface.

### Comparative Example 1

A comparative fuel cell 1 was produced in the same manner as in Example 1 except that the cathode catalyst layer was a layer composed only of the first region. Specifically, the cathode catalyst layer was formed by spray coating using only the first catalyst ink.

### Comparative Example 2

A comparative fuel cell 2 was produced in the same manner as in Example 1 except that the cathode catalyst layer was a layer composed only of the second region. Specifically, the cathode catalyst layer was formed by spray coating using only the second catalyst ink.

### Comparative Example 3

A comparative fuel cell 3 was produced in the same manner as in Example 1 except for the formation of a cathode catalyst layer in which the amount of polymer electrolyte was changed in the thickness direction. Specifically, the half of the cathode catalyst layer on the electrolyte membrane side in the thickness direction was a layer composed only of the first region, while the half of the cathode catalyst layer on the cathode diffusion layer side in the thickness direction was a layer composed only of the second region. That is, the first catalyst ink was reapplied 20 times onto the whole power generation area (6 cm×6 cm) of the electrolyte membrane in the thickness direction to form a layer composed of the first region. The second catalyst ink was then reapplied 20 times onto the whole layer composed of the first region in the thickness direction to form a layer composed of the second region.

### Comparative Example 4

A comparative fuel cell 4 was produced in the same manner as in Example 1 except for the formation of a cathode catalyst layer in which the amount of polymer electrolyte was changed in the thickness direction. Specifically, the half of the cathode catalyst layer on the electrolyte membrane side in the thickness direction was a layer composed only of the second region, while the half of the cathode catalyst layer on the cathode diffusion layer side in the thickness direction was a layer composed only of the first region. That is, the second catalyst ink was reapplied 20 times onto the whole power generation area (6 cm×6 cm) of the electrolyte membrane to form a layer composed of the second region. The first catalyst ink was then reapplied 20 times onto the whole layer composed of the second region to form a layer composed of the first region.

### COMPARATIVE EXAMPLE 5

A comparative fuel cell 5 was produced in the same manner as in Example 1 except for the formation of a cathode catalyst layer in which the amount of polymer electrolyte was changed in the direction parallel to the main surface of the cathode catalyst layer. Specifically, in the direction parallel to the main surface of the cathode catalyst layer, the area (6 cm×1.5 cm) of the cathode catalyst layer facing the upstream of the fuel flow channel was a layer composed only of the first region, while the area (6 cm×4.5 cm) facing the midstream and the downstream of the fuel flow channel was a layer composed only of the second region. That is, the first catalyst ink was reapplied 40 times onto the area (6 cm×1.5 cm) of the electrolyte membrane facing the upstream of the fuel flow channel to form a layer composed of the first region. The second catalyst ink was then reapplied 40 times onto the area (6 cm×4.5 cm) of the electrolyte membrane facing the upstream and the downstream of the fuel flow channel to form a layer composed of the second region.

### [Evaluation]

Using the fuel cells A to D produced in Examples 1 to 4 and the comparative fuel cells 1 to 5 produced in Comparative Examples 1 to 5, the effective reaction area of the cathode catalyst layer per unit area and durability were evaluated. The evaluation method is described below.

### (Effective Reaction Area of Cathode Catalyst Layer Per Unit Area)

The effective reaction area of each cathode catalyst layer per unit area was determined from the following formula:

(Effective reaction area of cathode catalyst layer)/(Area of cathode catalyst layer)

The results are shown in Table 1.

The effective reaction area of the cathode catalyst layer was determined by the following method.

With humidified nitrogen gas fed to the cathode and humidified hydrogen fed to the anode, a potential scan was performed between 0.07 to 0.6 V at 0.5 mV/cm by cyclic voltammetry (CV), to obtain a current-potential curve. From the current-potential curve, the amount of electricity generated through hydrogen gas adsorption/desorption was determined. This value was divided by the amount of electricity generated through hydrogen adsorption/desorption per 1 cm² of catalyst, to obtain the effective reaction area of the cathode catalyst layer. The amount of electricity generated through hydrogen adsorption/desorption per 1 cm² is a value intrinsic to a catalyst. For example, in the case of platinum (Pt), the amount of electricity generated through hydrogen adsorption/desorption per 1 cm² is 210 μC/cm².

In the above formula, the area of the cathode catalyst layer refers to the area (projected area) calculated from the shape of the contour of the cathode catalyst layer when the main surface of the cathode catalyst layer is seen from the direction of the normal thereto. The cathode catalyst layers used in Examples and Comparative Examples had an area of 36 cm² (6 cm (length)×6 cm (width)).

### <Durability>

With a 4M methanol aqueous solution fed to the anode at a flow rate of 0.27 cc/min and air fed to the cathode at a flow rate of 0.26 L/min, each fuel cell was operated to generate power at a constant voltage of 0.4 V. The cell temperature during the power generation was set to 60° C.

The value of power density was calculated from the value of current density after four-hour operation from the start of power generation. The obtained value was defined as initial power density. Then, from the value of current density after 3000-hour operation from the start of power generation, the value of power density was calculated. The ratio of the power density after 3000-hour operation to the initial power density was defined as power density retention rate. Table 1 shows the results. In Table 1, the current density retention rates are expressed in percentages.

Table 1 also shows the polymer electrolyte content in the first and second regions, the weight ratio of the polymer electrolyte to the conductive carbon particles (polymer electrolyte/conductive carbon particles), the structure of the cathode catalyst layer, and the initial power density of each cell.

TABLE 1

| | | | | | Durability | |
|---|---|---|---|---|---|---|
| | | | | | Initial | Power |
| | | Cathode catalyst layer | | | power | density |
| | | First | Second | Arrangement of first region and second | density | retention |
| | Physical value | region | region | region | [mW/cm²] | rate [%] |
| Fuel cell A | Polymer electrolyte content [wt %] | 24.5 | 15.9 | Slantwise relative to thickness direction | 92 | 96 |
| | Polymer electrolyte/Conductive carbon particles | 0.60 | 0.35 | | | |
| | Effective reaction area per unit area [cm²/cm²] | 875 | | | | |
| Fuel cell B | Polymer electrolyte content [wt %] | 22.9 | 19.5 | Slantwise relative to thickness direction | 88 | 95 |
| | Polymer electrolyte/Conductive carbon particles | 0.55 | 0.45 | | | |
| | Effective reaction area per unit area [cm²/cm²] | 843 | | | | |
| Fuel cell C | Polymer electrolyte content [wt %] | 24.5 | 15.9 | In a zigzag relative to thickness | 85 | 91 |
| | Polymer electrolyte/Conductive carbon particles | 0.60 | 0.35 | direction | | |
| | Effective reaction area per unit area [cm²/cm²] | 810 | | | | |
| Fuel cell D | Polymer electrolyte content [wt %] | 24.5 | 15.9 | In a zigzag relative to thickness | 77 | 90 |
| | Polymer electrolyte/Conductive carbon particles | 0.60 | 0.35 | direction | | |
| | Effective reaction area per unit area [cm²/cm²] | 775 | | (First regions are not continuous) | | |
| Comparative | Polymer electrolyte content [wt %] | 24.5 | — | Layer composed only of first region | 78 | 27 |
| fuel cell 1 | Polymer electrolyte/Conductive carbon particles | 0.60 | — | | | |
| | Effective reaction area per unit area [cm²/cm²] | 914 | | | | |
| Comparative | Polymer electrolyte content [wt %] | | 15.9 | Layer composed only of second region | 64 | 58 |
| fuel cell 2 | Polymer electrolyte/Conductive carbon particles | | 0.35 | | | |
| | Effective reaction area per unit area [cm²/cm²] | 726 | | | | |
| Comparative | Polymer electrolyte content [wt %] | 24.5 | 15.9 | Electrolyte membrane side half is a layer | 75 | 36 |
| fuel cell 3 | Polymer electrolyte/Conductive carbon particles | 0.60 | 0.35 | composed of first region, while diffusion | | |
| | Effective reaction area per unit area [cm²/cm²] | 822 | | layer side half is a layer composed of | | |
| | | | | second region | | |
| Comparative | Polymer electrolyte content [wt %] | 24.5 | 15.9 | Electrolyte membrane side half is a layer | 81 | 44 |
| fuel cell 4 | Polymer electrolyte/Conductive carbon particles | 0.60 | 0.35 | composed of second region, while | | |
| | Effective reaction area per unit area [cm²/cm²] | 856 | | diffusion layer side half is a layer | | |
| | | | | composed of first region | | |
| Comparative | Polymer electrolyte content [wt %] | 24.5 | 15.9 | Area facing upstream of fuel flow channel | 72 | 34 |
| Fuel cell 5 | Polymer electrolyte/Conductive carbon particles | 0.60 | 0.35 | is a layer composed of first region, | | |

| | | |
|---|---|---|
| Effective reaction area per unit area [cm²/cm²] | 834 | while area facing midstream and |
| | | downstream of fuel flow channel is a |
| | | layer composed of second region |

As shown in Table 1, the fuel cells A to D exhibited very high values for power density retention rate.

In the invention, instead of making the amount of polymer electrolyte uniform in the cathode catalyst layer or changing it in the thickness direction of the cathode catalyst layer, the second regions with a lower polymer electrolyte content were disposed continuously from the first main surface of the cathode catalyst layer to the second main surface. This configuration ensures that the cathode catalyst layer contains sufficient paths effective for oxidant diffusion and water removal across the thickness of the cathode catalyst layer. Thus, the three-phase interface (electrode reaction site) is enlarged, and cathodic overvoltage becomes small and stable. This is believed to be the reason for the improved durability of the fuel cells.

Of the fuel cells A to D, the fuel cells A and B exhibited significant improvements in durability. In the case of the fuel cells A and B, the first regions and the second regions are disposed regularly and continuously slantwise with respect to the thickness direction of the cathode catalyst layer. This configuration ensures that the cathode catalyst layer contains sufficient paths (continuous first regions) effective for proton conduction and sufficient paths (continuous second regions) effective for oxidant diffusion and water removal. As a result, it is possible to increase the evenness of the electrode reaction over the whole region of the cathode catalyst layer.

Further, this configuration can increase the contact area between the first regions and the second regions which are adjacent in the thickness direction, thereby making it possible to increase the three-phase interface where the cathode catalyst, the polymer electrolyte, and the oxidant coexist. As a result, it is possible to obtain a cathode catalyst layer with a small overvoltage.

This is believed to be the reason for the significant improvements in the durability of the fuel cells A and B.

Contrary to this, the power density retention rates of the comparative fuel cells 1 to 5 were significantly low, compared with those of the fuel cells A to D.

In the case of the comparative fuel cell 1, the cathode catalyst layer is a layer composed only of the first region. Thus, with the passage of power generation time, the polymer electrolyte gradually swells with crossover methanol and water, thereby decreasing the pore volume of the cathode catalyst layer and resulting in poor oxidant diffusion and low water removal ability. This is believed to be the reason for the significantly low power density retention rate.

In the case of the comparative fuel cell 2, the cathode catalyst layer is a layer composed only of the second region. It is thus difficult to ensure that the cathode catalyst layer contains sufficient paths effective for proton conduction. As a result, the three-phase interface (electrode reaction site) where the cathode catalyst, the polymer electrolyte, and the oxidant coexist decreases, thereby resulting in increased cathodic overvoltage. This is believed to be the reason for the significantly low power density retention rate.

In the case of the comparative fuel cells 3 and 4, the amount of polymer electrolyte is changed in the cathode catalyst layer. Hence, in the region with a higher polymer electrolyte content, the swelling of the polymer electrolyte decreases the pore volume of the cathode catalyst layer, thereby resulting in poor oxidant diffusion and low water removal ability. Also, in the region with a lower polymer electrolyte content, it is difficult to ensure sufficient paths effective for proton conductivity. This is believed to be the reason for the significantly low durability.

In the case of the comparative fuel cell 5, the amount of polymer electrolyte is changed in the direction parallel to the main surface of the cathode catalyst layer, so that the amount of polymer electrolyte contained in the area of the cathode catalyst layer facing the upstream of the fuel flow channel is larger than the amount of polymer electrolyte contained in the area of the cathode catalyst layer facing the midstream and downstream of the fuel flow channel. Hence, in the area of the cathode catalyst layer facing the upstream of the fuel flow channel where a large amount of methanol crossover occurs, the swelling of the polymer electrolyte significantly decreases the pore volume, thereby resulting in poor oxidant diffusion and water removal ability. This is believed to be the reason why the power density retention rate of the comparative fuel cell 5 was significantly low.

As described above, the invention can provide a cathode catalyst layer with a small overvoltage, in which sufficient proton conductivity is ensured and the decrease in the pore volume due to the swelling of the polymer electrolyte is suppressed. As a result, it is possible to provide a direct oxidation fuel cell having excellent power generation performance and durability.

The direct oxidation fuel cell of the invention is excellent in power generation performance and durability, thus being useful as the power source for portable, small-sized electronic devices such as cell phones, notebook personal computers, and digital still cameras. Further, the direct oxidation fuel cell of the invention can also be used as the power source for, for example, electric scooters and automobiles.

Although the invention has been described in terms of the presently preferred embodiments, it is to be understood that such disclosure is not to be interpreted as limiting.

Various alterations and modifications will no doubt become apparent to those skilled in the art to which the invention pertains, after having read the above disclosure. Accordingly, it is intended that the appended claims be interpreted as covering all alterations and modifications as fall within the true spirit and scope of the invention.

1. A membrane electrode assembly for a direct oxidation fuel cell, comprising:
an electrolyte membrane;
an anode disposed on one face of the electrolyte membrane; and
a cathode disposed on the other face of the electrolyte membrane, the cathode including a cathode catalyst layer with a first main surface and a second main surface, the cathode catalyst layer including a cathode catalyst and a polymer electrolyte,
wherein the cathode catalyst layer includes a plurality of first regions and a plurality of second regions,
the first regions and the second regions are different in polymer electrolyte content,
the polymer electrolyte content in each of the second regions is lower than the polymer electrolyte content in each of the first regions, and
the second regions are continuous from the first main surface of the cathode catalyst layer to the second main surface.

2. The membrane electrode assembly in accordance with claim 1, wherein the cathode catalyst layer comprises a plurality of thin layers accumulated in the thickness direction, and each of the thin layers includes at least one of the first regions and at least one of the second regions.

3. The membrane electrode assembly in accordance with claim 2,
wherein the second regions included in the thin layers are continuous from the first main surface to the second main surface along a line slanted at a predetermined angle with respect to the thickness direction of the cathode catalyst layer, and
each of the first regions included in one of the thin layers is partially in contact with each of the second regions included in an adjacent one of the thin layers.

4. The membrane electrode assembly in accordance with claim 2,
wherein the second regions included in the thin layers are disposed in a zigzag from the first main surface to the second main surface, and
each of the first regions included in one of the thin layers is partially in contact with each of the second regions included in an adjacent one of the thin layers.

5. The membrane electrode assembly in accordance with claim 1, wherein the first regions and the second regions are disposed regularly in the thickness direction of the cathode catalyst layer or the direction perpendicular to the thickness direction.

6. The membrane electrode assembly in accordance with claim 1, wherein the first regions and the second regions are disposed irregularly in the thickness direction of the cathode catalyst layer or the direction perpendicular to the thickness direction.

7. The membrane electrode assembly in accordance with claim 1, wherein the first regions are disposed discontinuously in the thickness direction of the cathode catalyst layer.

8. The membrane electrode assembly in accordance with claim 1, wherein the first regions are continuous from the first main surface of the cathode catalyst layer to the second main surface.

9. The membrane electrode assembly in accordance with claim 1,
wherein the cathode catalyst is loaded on conductive carbon particles, and
the weight ratio B of the polymer electrolyte to the conductive carbon particles in each of the second regions is lower than the weight ratio A of the polymer electrolyte to the conductive carbon particles in each of the first regions.

10. The membrane electrode assembly in accordance with claim 9, wherein the weight ratio A of the polymer electrolyte to the conductive carbon particles in each of the first regions is from 0.5 to 0.7, and the weight ratio B of the polymer electrolyte to the conductive carbon particles in each of the second regions is from 0.3 to 0.5.

11. The membrane electrode assembly in accordance with claim 9, wherein the difference between the weight ratio A and the weight ratio B is 0.1 or more.

12. The membrane electrode assembly in accordance with claim 1, wherein the cathode is a laminate of the cathode catalyst layer and a cathode diffusion layer including a conductive porous substrate, and the cathode catalyst layer is disposed so as to contact the electrolyte membrane.

13. A unit cell for a direct oxidation fuel cell, comprising the membrane electrode assembly of claim 12, and an anode separator and a cathode separator which sandwich the membrane electrode assembly.

14. A direct oxidation fuel cell comprising the unit cell of claim 13.
